(19) United States
(12) Patent Application Publication
(10) Pub. No.: US 2025/0248428 A1
(43) Pub. Date: Aug. 7, 2025

(54) PLANT BASED WHIPPING CREAM

(71) Applicant: SOCIETE DES PRODUITS NESTLE S.A., Vevey (CH)

(72) Inventors: MARINA BORTOLIN, Lausanne (CH); HELENE DEYBER, Jougne (FR); SOPHIE GROULT, Epalinges (CH); SHENGLE LI, Beijing (CN); ARMAND ROUCHER, Lausanne (CH); LAURENT SAGALOWICZ, Blonay (CH); AXEL SYRBE, Clarens (CH)

(21) Appl. No.: 18/856,125

(22) PCT Filed: Apr. 12, 2023
(86) PCT No.: PCT/EP2023/059561

§ 371 Date: Oct. 11, 2024

(30) Foreign Application Priority Data
Apr. 13, 2022 (WO) PCT/CN2022/086634

(51) Int. Cl. A23L 9/20; A23D 7/005; A23D 7/01; A23D 7/04

(52) U.S. Cl. CPC A23L 9/24; A23D 7/0053; A23D 7/011; A23D 7/04

(57) ABSTRACT

The present invention relates to an emulsion composition comprising 1 to 5% wt non-fractionated chickpea; 0.25 to 3%_{wt} non-fractionated oat; 20.5 to 35%_{wt} lipid source; and 50 to 75%_{wt} water. Preferred emulsion compositions further comprise non-fractionated lentil. Whipped cream compositions made from the emulsion composition are also provided.

### INTRODUCTION

Whipped cream is a popular topping for beverages, such as coffee, ice slashes, milk shakes, hot chocolate, on fruit, and on desserts such as pies, cupcakes, and waffles. It can also be used as a filling for profiteroles and layer cakes. The cream should be in a liquid or gel form before whipping which is usually by aeration, either with a mechanical device such as a whisk or electric mixer, or with an instant whipping device and use of nitrous oxide.

Consumers today are interested in plant based alternatives to conventional whipping cream. Most commercial products require to be transported and stored frozen then thawed before use, while some require to be transported and stored chilled. This creates handling complexity and higher chance of failure during use.

Commercial products typically have a long list of additives and other ingredients to improve performance, thus limiting their desirability to consumers. Furthermore, these commercial whipped creams tend to destabilize fast and are unable to retain their original shape for very long, thus limiting their application.

There is a strong need for superior plant based alternative products with improved liquid stability, which have fewer additives but that still meet consumer expectations in terms of foam stability.

### EMBODIMENTS OF THE INVENTION

The invention relates in general to an emulsion composition, said composition comprising legume, cereal, lipid, and water.

In particular, the invention relates to an emulsion composition, said composition comprising chickpea, oat, lipid, and water. Typically, the chickpea and oat are non-fractionated, for example chickpea flour and oat flour.

The invention relates to an emulsion composition, said composition comprising
a. 1 to 5%_{wt} non-fractionated chickpea;
b. 0.25 to 3%_{wt} non-fractionated oat;
c. 20.5 to 35%_{wt} lipid source; and
d. 50 to 75%_{wt} water.

In preferred embodiments, the composition further comprises 1 to 5%_{wt} non-fractionated pulse, preferably non-fractionated lentil, preferably lentil flour.

In preferred embodiments, the composition comprises 0.5 to 3%_{wt} protein. Preferably, the composition comprises 0.5 to 2%_{wt} protein. More preferably, the composition comprises 0.5 to 1%_{wt} protein.

In preferred embodiments, greater than 50% of the protein is provided by the non-fractionated chickpea and non-fractionated oat. Preferably, greater than 80% of the protein is provided by the non-fractionated chickpea and non-fractionated oat. More preferably, greater than 80% of the protein is provided by the non-fractionated chickpea, non-fractionated oat, and non-fractionated lentil. Most preferably, greater than 90% of the protein is provided by the non-fractionated chickpea, non-fractionated oat, and non-fractionated lentil.

In preferred embodiments, the non-fractionated chickpea is chickpea flour and the non-fractionated oat is oat flour. Preferably, the oat flour is hydrolyzed oat flour.

In preferred embodiments, the lipid source is coconut oil.

In preferred embodiments, the composition further comprises monoglyceride. In preferred embodiments, the composition further comprises lecithin, monoglyceride, and polysorbate. In preferred embodiments, the composition further comprises gum, lecithin, monoglyceride, and polysorbate.

In preferred embodiments, the monoglyceride comprises a minimum 90% of monoglycerides from edible and fully hydrogenated palm oil.

In preferred embodiments, the emulsion is dairy free.

In preferred embodiments, the emulsion is devoid of animal products.

The invention further relates to a whipped cream composition, made from the emulsion according to the invention.

In preferred embodiments, the emulsion is poured into a siphon and cooled before whipping. The cooling step can be last about 24 hours.

In preferred embodiments, nitrous oxide is dispersed in the siphon before whipping.

The invention further relates to a method of making an emulsion composition, said method comprising
a. Mixing 1 to 10%_{wt} non-fractionated legume, 0.2 to 5%_{wt} non-fractionated cereal, and optionally 0.2 to 5%_{wt} non-fractionated pulse, in water to form a mixture;
b. Heating the mixture;
c. Adding a lipid source to the mixture;
d. Applying high shear mixing to the mixture;
e. Applying a thermal heat treatment to the mixture;
f. Homogenizing the mixture to form an emulsion composition.

In preferred embodiments, the non-fractionated legume is chickpea flour. In preferred embodiments, the non-fractionated cereal is oat flour.

In preferred embodiments, the non-fractionated pulse is lentil flour.

In preferred embodiments, the mixture is heated to at least 55° C. in step b). Preferably, the mixture is heated to at least 60° C.

In preferred embodiments, the mixture comprising the lipid source is homogenized at about 100 bars.

In preferred embodiments, the mixture after homogenization in step f) comprises lipid droplets having a maximum diameter greater than 0.5 microns, preferably between 0.5 to 5 microns.

In preferred embodiments, the mixture after homogenization in step f) comprises flour particles having a maximum diameter greater than 10 microns.

In preferred embodiments, the mixture after homogenization in step f) has a viscosity higher than 10 mPa s, preferably between 10 to 150 mPa s as measured at 20° C. at a shear rate of 100 s-1.

The invention further relates to the use of 1 to 10%_{wt}, or 3 to 10%_{wt}, non-fractionated chickpea, 0.2 to 5%_{wt} non-fractionated oat, and optionally 1 to 5%_{wt} non-fractionated lentil in the manufacture of an emulsion composition or a whipped cream composition.

### DETAILED DESCRIPTION OF THE INVENTION

### Non-Fractionated

The term “non-fractionated” typically refers to a flour preparation. It does not refer to a protein concentrate or protein isolate preparation. In the case of non-fractionated chickpea, this can be prepared from whole chickpea which has or has not been split or dehulled.

### Non-Fractionated Legume

The non-fractionated legume is typically a legume flour. Preferably, the non-fractionated legume is chickpea flour.

Chickpea flour comprises at least 10%_{wt} protein, more preferably at least 20%_{wt}. protein. Chickpea flour comprises at least 30%_{wt} starch, more preferably at least 40%_{wt} starch.

The particle size of the chickpea flour is less than 150 μm for at least 90%_{wt}. of the flour as measured by Hosokawa size analysis.

### Non-Fractionated Cereal

The non-fractionated cereal is typically a cereal flour. Preferably, the non-fractionated cereal is oat flour.

Oat flour comprises at least 10%_{wt} protein, more preferably at least 20%_{wt}. protein. Oat flour comprises at least 30%_{wt} starch, more preferably at least 40%_{wt} starch.

The particle size of the oat flour is less than 150 μm for at least 90%_{wt}. of the flour as measured by Hosokawa size analysis.

Preferably, the oat flour is hydrolyzed. Hydrolyzed oat flour typically comprises at least 12%_{wt} protein and 80%_{wt} carbohydrates.

### Non-Fractionated Pulse

The non-fractionated pulse is typically a pulse flour. Preferably, the non-fractionated pulse is lentil flour.

### Lipid Source

Preferably, the lipid source is coconut oil. The coconut oil typically has a melting point between 22 to 24° C. It typically contains about 0.1% free fatty acid (FFA) and has a solid fat content (SFC) of about 75% at 10° C., about 35% at 20° C., and about 1% at 25° C. The dropping point is typically between 26 and 27° C.

### Emulsifier

The emulsion composition may comprise one or more emulsifiers. The emulsifier may be a fat soluble emulsifier. Preferably, the emulsifier is added to the fat source. The emulsifier may be present at a concentration of between 005 to 0.5%_{wt} of the emulsion. The emulsifier can be, for example, a monoglyceride. The emulsifier can be, for example, a diglyceride. The emulsifier can be, for example, a phospholipid mixture such as a lecithin. The lecithin can be derived, for example, from sunflower, rapeseed, or soy. The lecithin may be a de-oiled powder or be in liquid form with reduced phospholipid content.

The emulsifier may comprise at least 90% monoglcerides, for example from edible and fully hydrogenated palm oil.

The emulsifier may comprise lecithin derived from sunflower, for example de-oiled powdered sunflower lecithin. Preferably, the lecithin has 80% particles below 315 microns.

The emulsifier may be a mixture of monoglyceride and polysorbate.

### Thickener

The emulsion may further comprise one or more thickeners. Typically, the thickeners are present at between 0.025 to 0.5%_{wt} of the emulsion. The thickener can be a starch already present in the flour. The starch can be derived from rice or potatoes. The thickener can be a gum, for example, xanthan gum, guar gum, gellan gum, or carrageenan gum. The thickener can be MCC (microcrystalline cellulose). The thickener can be CMC (carboxymethyl cellulose). The thickener can be a combination of microcrystalline cellulose and carboxymethyl cellulose.

### Nutritional Content of Emulsion

The emulsion may comprise between 20.5 to 35%_{wt} lipid, or between 23 to 28%_{wt} lipid. The emulsion may comprise between 0.5 to 1% w protein.

### Emulsions

The emulsion may comprise chickpea flour, hydrolyzed oat flour, water, coconut oil, and monoglyceride. The emulsion may comprise about 0.95%_{wt} protein. In this emulsion, the ratio of chickpea flour to hydrolyzed oat flour may be about 1:1, for example between 1:1 to 4:1. The emulsion may further comprise lentil flour. In this emulsion, the ratio of chickpea flour to lentil flour is about 1:1, and the ratio of chickpea flour to hydrolyzed oat flour is greater than 1:1, for example between 1:1 to 2:1.

The emulsion may comprise chickpea flour, hydrolyzed oat flour, cellulose gum, coconut oil, sunflower lecithin, monoglyceride, and polysorbate. The emulsion may comprise about 0.56%_{wt} protein. In this emulsion, the ratio of hydrolyzed oat flour to chickpea flour can be greater than 1:1, for example between 1:1 to 2:1.

The emulsion is preferably devoid of dairy products, more preferably devoid of animal products.

### Particle Size

The emulsion may comprise oil droplets of between 0.5 to 5 microns, as observed under an optical microscope. The flour particles may be between 10 to 100 microns, as observed under an optical microscope.

### Viscosity

The emulsion comprising chickpea flour, hydrolyzed oat flour, water, coconut oil, and monoglyceride may have a viscosity between 100 to 150 mPa·s as measured at 20° C. at a shear rate of 100 s-1. When the emulsion further comprises lentil flour, the emulsion may have a viscosity between 45 to 70 mPa·s as measured at 20° C. at a shear rate of 100 s-1.

The emulsion comprising chickpea flour, hydrolyzed oat flour, cellulose gum, coconut oil, sunflower lecithin, monoglyceride, and polysorbate may have a viscosity between 20 to 40 mPa·s as measured at 20° C. at a shear rate of 100 s-1.

### Process Steps to Make Emulsion

The aqueous phase comprising the flours is preferably heated, for example to at least 60° C., preferably to between 60 to 70° C. This optimizes the dispersion.

The lipid source is preferably heated, for example to at least 60° C., preferably to between 60 to 70° C. This allows a clear liquid lipid phase to be obtained.

The aqueous phase and the lipid source are preferably mixed under high shear, for example at least 10 minutes. This allows the formation of a pre-emulsion.

The pre-emulsion is preferably heated to at least 75° C. The pre-emulsion is preferably then ultra-heat treated to at least 145° C. for at least 5 seconds, preferably with steam.

After ultra-heat treatment, the mixture is preferably cooled to about 75° C. and homogenized, for example at a pressure of about 100 bars.

The mixture is then cooled to form an emulsion, for example to about 20° C. Typically, the emulsion is then transferred to sterile containers.

### Overrun

The emulsion can be whipped to form a whipped cream.

The whipped cream comprising chickpea flour, hydrolyzed oat flour, water, coconut oil, and monoglyceride may have an overrun between 230 to 340%, or about 285%. When the emulsion further comprises lentil flour, the emulsion may have an overrun between 350 to 450%, or about 400%.

The emulsion comprising chickpea flour, hydrolyzed oat flour, cellulose gum, coconut oil, sunflower lecithin, monoglyceride, and polysorbate may have an overrun between 310 to 390%, or about 350%.

### Process Steps to Make Whipped Cream

Typically, the emulsion is poured into a siphon and cooled for 24 hours before whipping. The cooling allows the crystallization of the fat. This crystallization step is crucial to obtain a high performance and stable product. Before whipping, nitrous oxide (N2O) is dispersed with a cartridge in the siphon. The gas will dissolve in the aqueous phase and lead to the formation of air bubbles when the product is released. These air bubbles will be stabilized by the crystals resulting from the crystallization of the fat and the interfacial crystallization of emulsifier. This process makes it possible to obtain foams with a very high overrun (higher than 200%) and the overall viscosity of the product avoids creaming phenomena without the use of stabilizing additives.

### Definitions

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth, this means %_{wt} of the emulsion, unless indicated otherwise.

The present invention can be further illustrated by the following examples which are not intended to limit the scope of the invention.

### EXAMPLES

### Example 1

### General Process Steps and Ingredient Details

The general process steps used to make the emulsion of the invention are as follows:
an aqueous phase comprising the flours is heated to 60-70° C. under stirring in a steel tank to optimize the dispersion;
The lipid phase is heated separately at a temperature between 6° and 70° C. in an oven until a clear liquid oil phase is obtained;
The aqueous and lipid phases are mixed with a high shear mixer to form a pre-emulsion for at least 10 minutes before being transferred to the sterilization tank;
The pre-emulsion is heated to about 75° C. before being sterilized by UHT treatment (with steam) at 145° C. for 5 seconds;
After the sterilization step, the mixture is cooled to 75° C. and homogenized at a pressure of about 100 bars; and
The homogenized and sterile product is then cooled to 20° C. before being packed in sterile aseptic bottles and stored in different conditions (ambient temperature or chilled at 4-5° C.).

Different flours were used in the emulsions. Chickpea flour and lentil flour both contain at least 20%_{wt}. protein and 40%_{wt} starch. The particle size of these flours was less than 150 μm for at least 90%_{wt}. of the powder as measured by Hosokawa size analysis. Hydrolyzed oat flour typically contains at least 12%_{wt} protein and 80%_{wt} carbohydrates.

The coconut oil (22-24 mp) typically contains about 0.1% free fatty acid (FFA) and a solid fat content (SFC) of 75% at 10° C., 35% at 20° C., and 1% at 25° C. The dropping point is between 26 and 27° C.

The emulsion can also comprise different emulsifiers. The fat-soluble emulsifiers were surprisingly found to improve the structure of the emulsion and give it desirable properties during whipping. These emulsifiers are added to the lipid phase at concentrations of between 0.05 and 0.5%_{wt} of the emulsion. Some of the emulsifiers used are monoglycerides and diglycerides. These emulsifiers were found to promote emulsion stability and the formation of a crystalline fat network during whipping. It is the latter that allows to obtain whipping creams with high overruns and good stability.

Another class of emulsifiers that can be used are the phospholipids. Lecithins are mixtures of phospholipids and can be produced from a variety of sources such as sunflower lecithin, rapeseed lecithin or soy lecithin. These lecithins are available as powders (de-oiled) or in liquid form (lower phospholipid content).

The emulsifiers used were:
Monoglyceride from a commercial source which comprises a minimum 90% of monoglycerides from edible and fully hydrogenated palm oil.
Sunflower lecithin from a commercial source which is de-oiled powdered sunflower lecithin with a minimum of 80% of particles sized below 315 μm.
Emulsifier from a commercial source which is a mixture of monoglycerides and polysorbate.

The addition of thickeners increased the viscosity of the cream and thus slowed down the cremation phenomena that can lead to phase separation in the long term. These thickeners were typically added at concentrations of between 0.025 and 0.5%_{wt} of the emulsion. These thickeners can be starches which are already present in the flours but also in other ingredients such as rice or potatoes. It is also possible to use gums such as cellulose gum, xanthan gum, guar gum, gellan gum or carrageenan gum.

### Example 2

### Formulation of Emulsions

Different emulsions were prepared according to Table 1 below. The emulsions were formulated with the process described above, with a fat content ranging from 23 to 28%_{wt} and a protein content ranging from 0.5 to 1%_{wt} of the emulsion.

The rheological properties of the emulsions were measured at different temperatures (4° C. and 20° C.) and during storage to measure their flowability and viscosity evolution in time.

TABLE 1

| | | Emulsions (%_{wt}) | | | |
|---|---|---|---|---|---|
| | Ingredients | V1 | V2 | V3 | V4 |
| Aqueous | Chickpea flour | 3.49 | 1.74 | 3.49 | 1.30 |
| phase | Lentil flour | — | 1.76 | — | — |
| | Hydrolyzed | 1.04 | 1.04 | 1.04 | 2.10 |
| | Oat flour | | | | |
| | MCC + CMC | — | — | — | 0.30 |
| | Water | 70.22 | 70.20 | 67.22 | 72.80 |
| Lipid phase | Coconut oil | 25 | 25 | 28 | 23 |
| | Monoglyceride | 0.25 | 0.25 | 0.25 | — |
| | Sunflower | — | — | — | 0.1 |
| | Lecithin | | | | |
| | Monoglyceride | — | — | — | 0.4 |
| | Polysorbate | | | | |

| | | | | |
|---|---|---|---|---|
| Protein content (%_{wt}) | 0.95 | 0.95 | 0.95 | 0.56 |

### Example 3

### Emulsion Properties and Application Test

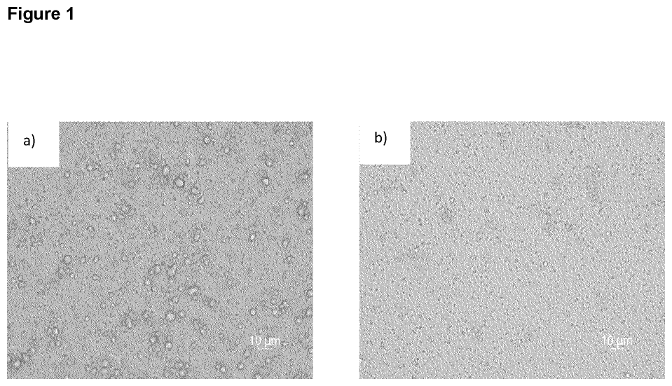

All emulsions presented above were characterized and tested under different conditions. After processing, all emulsions were observed under an optical microscope to study the droplet size and the dispersion state of the emulsions. The emulsions present oil droplets with sizes between 0.5 and 5 μm and the presence of starch and fibers contained in the flour whose size is between 10 to 100 microns. A regular observation during storage is necessary to study the evolution of the emulsion and in particular the phenomena of instability or aggregation. The emulsions have very different droplet size and structure. This is due to the different interfacial properties of the proteins and their ability to stabilize oil droplets. Thus, depending on the type of application desired, it is possible to combine the plant proteins in different ratios in order to modulate the properties of the emulsion and thus of the final whipped cream. FIG. 1 shows a micrograph of emulsion droplet size and aggregation state of a) emulsion V1 and b) emulsion V2.

The rheological properties of the emulsions were measured. Indeed, to use these emulsions as vegetable whipped creams, the emulsion should flow easily at room temperature and at chilled temperatures.

During storage, the viscosity of the emulsion can increase. This is due to a thickening of the structure linked to coalescence or crystallization of the fat. The flow properties of the emulsions were measured at 4 and 20° C. over a period of 3 months.

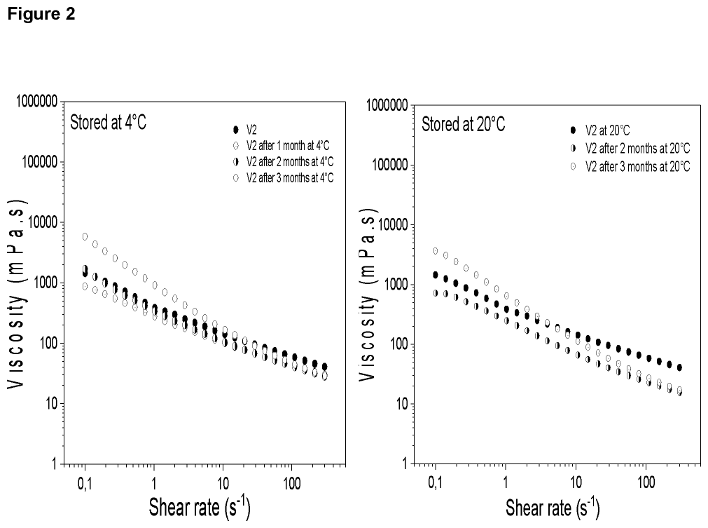

The evolution of viscosity versus shear rate during storage at 4° C. and 20° C. for the V2 formulation is shown in FIG. 2. The initial viscosity was similar at 4° C. and 20° C. and was found to change very little during storage. This means that despite prolonged storage at 4° C., the emulsion remained fluid and easy to pour before use. The other emulsions present a classical shear thinning profile where the viscosity decreases with increase of shear rate. The difference is the viscosity at lower shear rate for the chilled samples which are a bit higher for V1 and V3. V4 is close to V2. For the samples stored at room temperature, the viscosity profile is similar for all the emulsions with a slightly higher viscosity for V1 and V3.

Initial viscosities 24h after production of the emulsions at 4° C. and 20° C. are presented in Table 2 below.

TABLE 2

| Temperature | | Initial viscosity (mPa · s) | | | |
|---|---|---|---|---|---|
| (° C.) | Shear rate (s⁻¹) | V1 | V2 | V3 | V4 |
| 4 | 10 | 613 | 134 | 468 | 163 |
| | 100 | 122 | 59 | 114 | 64 |
| 20 | 10 | 628 | 145 | 470 | 100 |
| | 100 | 131 | 57 | 120 | 32 |

For each emulsion, the viscosity is almost identical after 24 h at 4° C. and 20° C. (at equivalent shear rate). On the other hand, the emulsion containing a mixture of chickpea and oat (V1) presents a higher viscosity than the mixture containing a mixture of chickpea, lentil and oat (V2). The addition of lentils allows a modulation of the viscosity and thus leading to whipped cream with different properties, opening the field to other applications. A slightly thicker cream will lead to a whipped cream which is less aerated but firmer. On the other hand, a fluid cream will lead to a very aerated whipped cream which is softer. This is mainly controlled by the viscosity of the continuous (aqueous) phase which will allow to stabilize the overall structure through a slightly thicker network.

There are different methods of whipping. For mechanical whipping, between 500 mL and 1000 mL of emulsion was poured into a bowl and whipped with a professional device like a Hobart or a KitchenAid. Whipping was stopped when the cream reached a sufficient volume and firmness to stay on the whisk.

For an instant whipping, typically about 500 mL of emulsion was poured into a stainless-steel siphon. The siphon was then closed and prior to whipping, between 7 to 9 g of gas (N₂O) was dispersed with a cartridge in the siphon. The gas dissolved in the aqueous phase and led to the formation of air bubbles when the product was released. The siphon was then shaken vigorously head up for at least 8 times and again 8 times head down. After shaking, a rosette of whipped cream was formed on a tray. The texture should be firm and the edges well defined.

After whipping the formulas were characterized by their overrun according to the following formula:

$$overrun ( \% ) = \frac{{m}_{1} - {m}_{2}}{{m}_{2}} \times 100$$

Where m₁ is the mass of the emulsion before whipping measured in a small cup and m₂ is the mass after whipping measured in the same cup.

After whipping an overrun of at least 100% was necessary to consider the formulation acceptable. The overrun after instant whipping at 4° C. in siphon for the emulsions are presented in Table 3.

TABLE 3

| | V1 | V2 | V3 | V4 |
|---|---|---|---|---|
| Overrun (%) | 290 | 400 | 280 | 350 |

The calculated overrun values for the different emulsions show that the nature of the proteins plays an important role in the final performance of the foam. The whipped cream containing lentil proteins had a higher overrun. The chickpea one had a similar overrun regardless of the fat content.

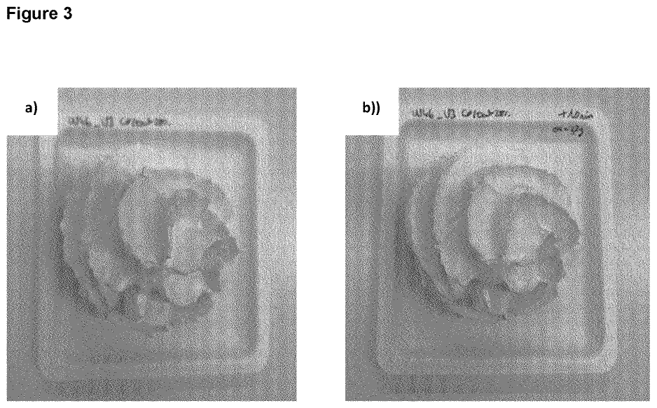

In order to observe the stability of the whipped creams at room temperature, the rosettes were visually inspected after 10 minutes on a tray. The rosettes should keep their shape and the edges should remain well defined. An example for the emulsion V3 is shown in FIG. 3.

The stability of the whipped creams was also studied by rheological measurements in tempering. For this tempering the foams were heated from 4 to 25° C. under oscillation with constant strain and frequency. The study of the values of the storage (G′) and loss (G″) moduli allowed to determine the stability of the whipped cream at ambient temperature.

The emulsions were subject to temperature cycling. The products were maintained at 25° C. in an oven before being cooled to 4° C. for 24 hours and then heated again to 25° C. for 24 hours. This temperature cycle was repeated three times and the properties of the emulsions after temperature cycles were studied, in particular the viscosity and flowability, whipping performance, droplet size and microscopic observation.

Another studied property of whipped cream is the hardening after whipping or inside the siphon after 24 hours in the refrigerator.

For this, after the first rosettes are formed, the siphon is placed in the refrigerator for 24 hours and a new rosette formed the next day. If after 24 hours in the siphon, it was not possible to form a rosette, the whipped cream was considered unacceptable. In the case of V1, V3, and V4, it was possible to form a rosette but some of the residue cream remained in the siphon. V2 performed best because it had no residues.

1. An emulsion composition, said composition comprising
a. 1 to 5%_{wt} non-fractionated chickpea;
b. 0.25 to 3%_{wt} non-fractionated oat;
c. 20.5 to 35%_{wt} lipid source; and
d. 50 to 75%_{wt} water.

2. The composition according to claim 1, wherein the composition further comprises 1 to 5%_{wt} non-fractionated lentil.

3. The composition according to claim 1, wherein the composition comprises 0.5 to 1%_{wt} protein.

4. The composition according to claim 2, wherein greater than 90% of the protein is provided by the non-fractionated chickpea, non-fractionated oat, and non-fractionated lentil.

5. The composition according to claim 1, wherein the non-fractionated chickpea is chickpea flour and the non-fractionated oat is hydrolyzed oat flour.

6. The composition according to claim 1, wherein the lipid source is coconut oil.

7. The composition according to claim 1, wherein the composition further comprises an emulsifier selected from the group consisting of
a. Monoglyceride, wherein said monoglyceride comprises a minimum 90% of monoglycerides from edible and fully hydrogenated palm oil;
b. Lecithin, monoglyceride, and polysorbate; and
c. Gum, lecithin, monoglyceride, and polysorbate.

8. The composition according to claim 7, wherein the emulsifier is monoglyceride, wherein said monoglyceride comprises a minimum 90% of monoglycerides from edible and fully hydrogenated palm oil.

9. A whipped cream composition, made from an emulsion composition, said composition comprising
a. 1 to 5%_{wt} non-fractionated chickpea;
b. 0.25 to 3%_{wt} non-fractionated oat;
c. 20.5 to 35%_{wt} lipid source; and
d. 50 to 75%_{wt} water.

10. A method of making an emulsion composition, said method comprising
a. Mixing 1 to 10%_{wt} non-fractionated legume, 0.2 to 5%_{wt} non-fractionated cereal, and optionally 0.2 to 5%_{wt} non-fractionated pulse, in water to form a mixture;
b Heating the mixture;
c. Adding a lipid source to the mixture;
d. Applying high shear mixing to the mixture;
e. Applying a thermal heat treatment to the mixture; and
f. Homogenizing the mixture to form an emulsion composition.

11. The method according to claim 10, wherein the non-fractionated legume is chickpea flour, and the non-fractionated cereal is hydrolyzed oat flour.

12. The method according to claim 10, wherein the non-fractionated pulse is lentil flour.

13. The method according to claim 10, wherein the mixture after homogenization in step f) comprises lipid droplets having a maximum diameter between 0.5 to 5 microns.

14. The method according to claim 10, wherein the mixture after homogenization in step f) has a viscosity between 10 to 150 mPa s as measured at 20° C. at a shear rate of 100 s-1.

15. (canceled)
